(19) United States
(12) Patent Application Publication
(10) Pub. No.: US 2008/0150614 A1
(43) Pub. Date: Jun. 26, 2008

(54) Method and system for dynamic supply voltage biasing of integrated circuit blocks

(76) Inventors: Peter Vancorenland, Austin, TX (US); Lawrence Der, Austin, TX (US); Scott D. Willingham, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/642,335

(22) Filed: Dec. 20, 2006

(51) Int. Cl. G05F 3/02

(52) U.S. Cl. 327/530

(57) ABSTRACT

A system and method are disclosed for using dynamic supply voltages to bias circuit blocks within integrated circuits. By considering current requirements for circuit blocks based upon process variations and environmental conditions, a dynamic supply voltage can be used such that operational integrity can be maintained while reducing power consumption. By using a dynamic supply voltage, circuit blocks can be operated at a desired speed while still reducing the power required for this operation. To implement this dynamic supply regulation, circuit elements are provided within a variable supply voltage circuit that cause the dynamic supply voltage to vary based upon operational parameters such as process variations and environment parameters. As such, circuit blocks can be provided a supply voltage high enough to allow operational integrity at required speeds but not so high as to waste power by unnecessarily increasing current consumption.

### TECHNICAL FIELD OF THE INVENTION

This invention relates to supply voltages and current requirements for circuit blocks within integrated circuits.

### BACKGROUND

Circuit blocks in integrated circuits often operate at a speed determined in part by the supply voltage applied to the circuit block. In addition, the operational speed of integrated circuit blocks will typically vary due to manufacturing process variations and environmental parameters, such as temperature changes. As these process and environmental conditions change for a given circuit block, both the maximum possible operational speed and current consumption of the circuit will also change. These variations can cause problems for integrated circuit due to performance degradations if speed capabilities drop too far. As such, integrated circuits are often designed such that operational integrity is maintained for the worst cases within an expected range of process variations and environmental conditions during circuit operation. However, this technique can cause an undesirable increase in power consumption where greater operational speed capabilities are provided than are needed by the circuit block during its operation.

### SUMMARY OF THE INVENTION

A system and method are disclosed for dynamic supply voltage biasing of circuit blocks within an integrated circuit. By providing a dynamic supply voltage for circuit blocks, operational integrity can be maintained while reducing power consumption. As described herein, a dynamic supply voltage can be correlated to process variations and environmental parameters so that circuit blocks can be operated at a desired speed while still reducing the power required for this operation. To implement this dynamic supply voltage regulation, circuit elements are provided within a variable supply voltage circuit that cause an output supply voltage to vary dynamically based upon operational parameters such as process variations or environment parameters or both. As such, circuit blocks can be provided a supply voltage high enough to allow operational integrity at required speeds but not so high as to waste power by unnecessarily increasing current consumption, and this supply voltage can dynamically adjust itself during operation. As described below, other features and variations can be implemented, if desired, and related systems and methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a diagram of a system for providing a dynamic supply voltage.

FIG. 2 is a diagram of speed versus supply voltage curve for different process variations.

FIG. 3A is a diagram of a dynamic biasing implementation.

FIG. 3B is a diagram showing changes in a dynamic supply voltage as a function of a reference voltage.

FIG. 4A is a diagram of dynamic biasing implementation as applied to a CMOS voltage controlled oscillator (VCO).

FIG. 4B is a diagram showing changes in a dynamic supply voltage as a function of a reference current.

### DETAILED DESCRIPTION OF THE INVENTION

A system and method are disclosed for dynamic supply voltages biasing based upon current requirements for circuit blocks within integrated circuits. By dynamically biasing the supply voltage for the circuit block based upon the current requirements for the circuit block, operational integrity can be maintained while reducing power consumption. As described below, a circuit block is provided a dynamic supply voltage high enough to allow operational integrity at required speeds but not so high as to waste power by unnecessarily increasing current consumption. To implement this dynamic supply regulation, circuit elements are provided within a variable supply voltage circuit that cause an output supply voltage to vary dynamically based upon operational parameters such as process variations or environment parameters or both. As described herein, the dynamic biasing of the supply voltage to the circuit block helps to lower overall current consumption, thereby improving the power performance of the circuit block and the integrated circuit.

FIG. 1 shows a system 100 within an integrated circuit for providing a dynamic supply voltage to circuit blocks. A circuit block 108 is supplied with a dynamic supply voltage (V_{SUPPLY}) 104 that is regulated by variable supply voltage circuitry 106. The variable supply voltage circuitry 106 is coupled between a supply voltage (V_{X}) 102 and ground and generates the dynamic supply voltage (V_{SUPPLY}) 1104. This dynamic supply voltage (V_{SUPPLY}) 104 is configured to provide enough power for the circuit block 108 to operate at a desired speed while not being so high as to cause unneeded current consumption by the circuit block 108. The variable supply voltage circuit 106 provides a dynamic supply voltage (V_{SUPPLY}) 104 to the circuit block 108 utilizing one or more circuit elements that vary a reference voltage and/or reference current based upon process variations or environmental parameters or both. As such, the circuit elements within the variable supply voltage circuit 106 cause the dynamic supply voltage (V_{SUPPLY}) 104 to vary dynamically such that a desired speed level is maintained for the circuit block 108 while still conserving power. It is noted that the supply voltage (V_{X}) 102 can be a regulated or unregulated voltage and can represent an externally or internally generated voltage, as desired. It is also noted that the circuit block 108 and the variable supply voltage circuitry 106 can be located within a single integrated circuit, and this single integrated circuit can be a CMOS integrated circuit.

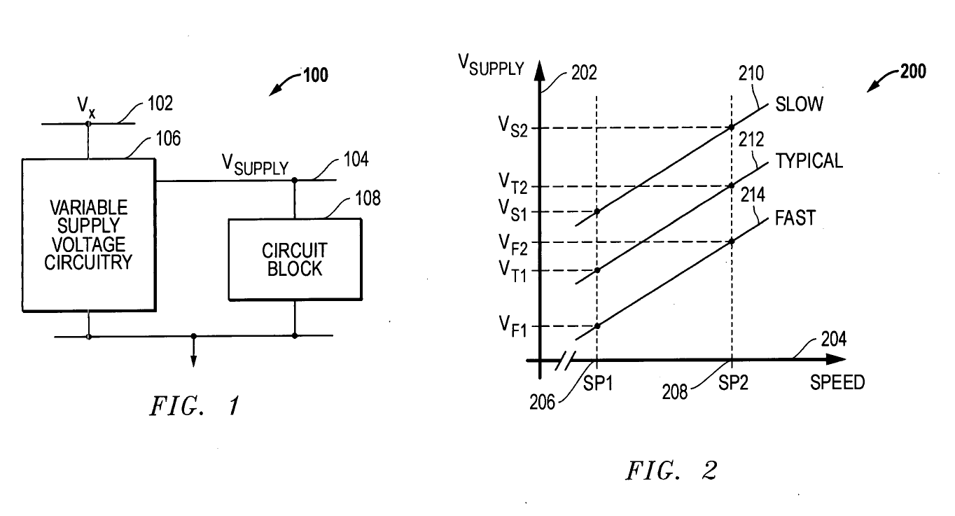

FIG. 2 shows a diagram 200 of speed versus supply voltage curve for a circuit based upon different process variations. The three lines 210, 212 and 214 represent three chip process variations: a slow process variation (SLOW) 210, a typical process variation (TYPICAL) 212, and fast process variation (FAST) 214. The x-axis 204 represents the speed of the circuit block, and the y-axis 202 represents the supply voltage (V_{SUPPLY}) applied to the circuit block. A first speed (SP1) 206 represents a first desired speed of operation for the circuit block, and a second speed (SP2) 208 represents a second desired speed of operation for the circuit block.

To achieve a desired operating speed, a certain level of supply voltage should be applied to the circuit block. For the first speed (SP1) 206, if the circuit block resulted from a slow process variation as represented by line (SLOW) 210, a first slow supply voltage level (V_{S1}) is applied to the circuit block to achieve the desired operating speed. If the circuit block resulted from a typical process variation as represented by line (TYPICAL) 212, a first typical supply voltage level (V_{T1}) is applied to the circuit block to achieve the desired operating speed. And if the circuit block resulted from a fast process variation as represented by line (FAST) 214, a first fast supply voltage level (V_{F1}) is applied to the circuit block to achieve the desired operating speed. Similarly, for the second speed (SP2) 208, if the circuit block resulted from a slow process variation as represented by line (SLOW) 210, a second slow supply voltage level (V_{S2}) is applied to the circuit block to achieve the desired operating speed. If the circuit block resulted from a typical process variation as represented by line (TYPICAL) 212, a second typical supply voltage level (V_{T2}) is applied to the circuit block to achieve the desired operating speed. And if the circuit block resulted from a fast process variation as represented by line (FAST) 214, a second fast supply voltage level (V_{F2}) is applied to the circuit block to achieve the desired operating speed. As can be seen with respect to FIG. 2, therefore, the operational speed for the circuit block increases as the supply voltage increases and varies based upon process variations. In particular, at a given supply voltage level, the operational speed is highest for a fast process variation (FAST) 214, lowest for a slow process variation (SLOW) 210, and in the middle for a typical process variation (TYPICAL) 212. And the supply voltage level needed to achieve a desired speed depends upon the process variation.

It is also noted that the operational speed of a circuit block will also vary according to environmental parameters, such as temperature. A similar diagram to FIG. 2 could be created to show operational speed variations based upon temperature changes. For example, if the fast-typical-slow process variations were changed to hot-medium-cool temperature levels, the relative supply voltage levels to achieve desired operational speeds would be similar. In other words, the higher the temperature, the lower the supply voltage would need to be in order to provide a desired operational speed. And the lower the temperature, the higher the supply voltage would need to be in order to provide a desired operational speed.

As described below, generating a supply voltage that varies dynamically based upon process variations and environmental parameters allows an efficient control of the current consumption of the part. This dynamic supply voltage biasing provides enough supply voltage to maintain a desired operation speed while reducing the amount of power that would have been consumed if a constant supply voltage were used that would be enough to handle any process variation and environmental change within an expected range of operation.

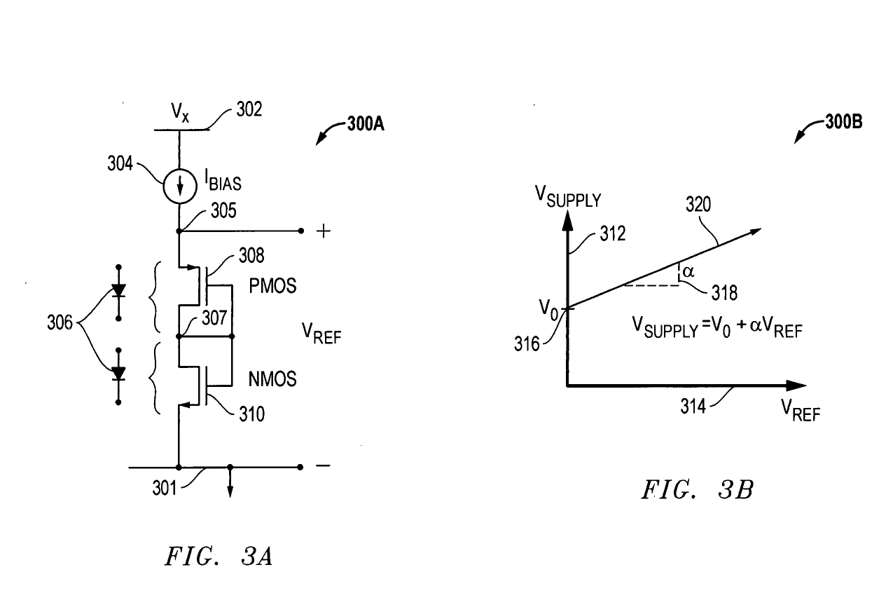

FIG. 3A shows a diagram of an example embodiment for dynamic biasing circuit implementation 300A. As depicted, current source (I_{BIAS}) 304 is coupled between a supply voltage (V_{X}) 302 and node 305. Node 305 is coupled to the source of PMOS (p-channel MOSFET) transistor 308. The gate and drain of PMOS transistor 308 are coupled to node 307. Node 307 is connected to the gate and drain of NMOS (n-channel MOSFET) transistor 310. The source of NMOS transistor 310 is coupled to ground 301. In this embodiment, PMOS transistor 308 and NMOS transistor 310 are each diode-connected, as represented by the diode symbols 306. An output reference voltage (V_{REF}) is generated between node 305 and ground 301.

In this example circuit embodiment, the voltage drop across the two diode-connected MOS transistors 308 and 310 will tend to vary with process variations and/or environment changes, such as temperature changes. As such, the output reference voltage (V_{REF}) will also tend to vary dynamically with process variations and/or environment parameters during operation of the integrated circuit. This variable output reference voltage (V_{REF}) can then be utilized to generate a dynamic supply voltage that will also dynamically vary with process variations and/or environment parameters. This dynamic supply voltage can then be used as an indication of the ideal supply voltage for a circuit block such that the circuit block can operate at a desired operational speed without consuming an unnecessary amount of current. The dynamic supply voltage will adjust itself based upon process variations and environmental changes so that an adequate supply voltage is provided to maintain desired operational speeds for the circuit block while reducing the current consumption from what would have been consumed using a constant supply voltage level set high enough to cover all expected process and environmental variations.

FIG. 3B provides a diagram 300B showing changes in a dynamic supply voltage as a function of a reference voltage. In this diagram 300B, the x-axis represents the level of the output reference voltage (V_{REF}), and the y-axis represents the level of the dynamic supply voltage (V_{SUPPLY}). As depicted, the dynamically regulated supply voltage (V_{SUPPLY}) is configured to follow a linear response 320 with respect to an output reference voltage (V_{REF}). In particular, the linear response 320 is configured to follow the equation V_{SUPPLY}=V_{O}+αV_{REF} where V_{O} represents an initial voltage level 316 and where α represents the slope 318 of the linear response 320. The output reference voltage (V_{REF}) can be implemented, for example, using the circuit of FIG. 3A, or any other desired circuit that will vary according to process and/or environmental variations. As stated above, by using this dynamically varying reference voltage (V_{REF}), a dynamic supply voltage (V_{SUPPLY}) can be generated and utilized to bias a circuit block within the integrated circuit.

It is noted that the slope (α) 318 for the linear response 320 can be selected to be any desired value. For example, a value of about one can be selected. Making the slope (α) 318 about one will tend to provide a stable solution. A value for the slope (α) 318 greater than one will tend to cause the dynamically regulated supply voltage (V_{SUPPLY}) to vary more aggressively, and the setup will typically be less reliable. A value for the slope (α) 318 smaller than one will typically cause the dynamically regulated supply voltage (V_{SUPPLY}) to vary less aggressively, and the setup will typically be more reliable. A value for the slope (α) 318 of zero will cause the regulated supply voltage (V_{SUPPLY}) to be constant. It is again noted, however, that the value for the slope (α) 318 can be selected as desired depending upon the operational objectives desired. It is also noted that relationships, other than a linear relationship, between the dynamic supply voltage (V_{SUPPLY}) and the dynamic output reference voltage (V_{REF}) can be utilized, as desired.

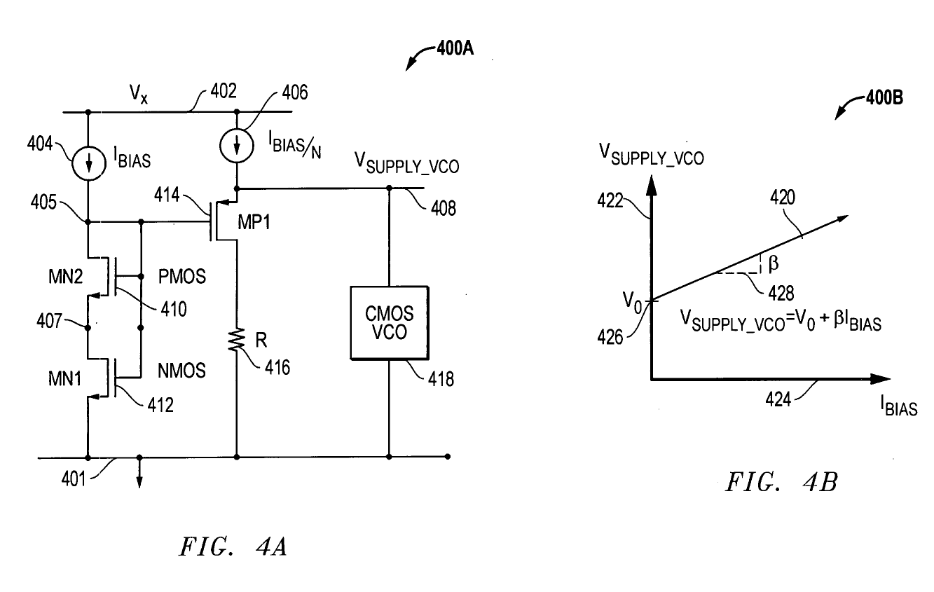

FIG. 4A shows a dynamic biasing implementation 400A as applied to a CMOS voltage controlled oscillator (VCO) within a CMOS integrated circuit. Current source (I_{BIAS}) 404 is coupled between supply voltage node (V_{X}) 402 and node 405. Node 405 is coupled to the gate and drain of NMOS transistor (MN2) 410, to the gate of NMOS transistor (MN1) 412, and the gate of PMOS transistor (MP1) 414. The source of NMOS transistor (MN2) 410 and the drain of NMOS transistor (MN1) 412 are coupled together at node 407. The source of NMOS transistor (MN1) 412 is coupled to ground 401. A resistor (R) 416 is coupled between ground 401 and the drain of PMOS transistor (MP1) 414. Current source (I_{BIAS}/N) 406 is coupled between supply voltage node (V_{X}) 402 and the dynamic supply voltage node (V_{SUPPLY}_{_{—}}_{VCO}) 408. The source of PMOS transistor (MP1) 414 is also coupled to dynamic supply voltage node (V_{SUPPLY}_{_{—}}_{VCO}) 408 and provides the dynamic supply voltage to the CMOS VCO 418. It is noted that the current source 406 is proportional in bias current strength to current source 404 by a factor of 1/N where N is an integer.

In this example circuit embodiment, the voltage drop across the two NMOS transistors 410 and 412 will tend to vary with process variations and/or environment changes, such as temperature changes. As such, the voltage at node 405 that is applied to the gate of PMOS transistor (MP1) 414 will also tend to vary dynamically with process variations and/or environment parameters during operation of the integrated circuit. In turn, this variable gate voltage for PMOS transistor (MP1) 414 will cause the voltage at its source, which is applied to node 408, to vary dynamically with process variations and/or environment parameters during operation of the integrated circuit. This output node 408 can then be used as a dynamically regulated supply voltage (V_{SUPPLY}) that will also vary with process variations and/or environment parameters. This dynamic supply voltage can then be used as a supply voltage for a circuit block such as CMOS VCO 418. As such, the CMOS VCO 418 can then operate a desired operational speed without consuming an unnecessary amount of current.

It is noted that for this implementation, the output voltage at node 408 will vary as a function of the bias current (I_{BIAS}) through the NMOS transistors 410 and 412 and the PMOS transistor 414. The NMOS transistor (MN1) 412 can be configured to operate in its triode region, and the NMOS transistor (MN2) 410 and the PMOS transistor (MP1) 414 can be configured to operate in their respective saturation regions. As such, the voltage characteristics of node 408, which is the source of PMOS transistor (MP1) 414, will vary according the bias current (I_{BIAS}). Thus, as the bias current (I_{BIAS}) varies with process and environmental variations, the voltage at node 408 will also vary, and this voltage can be used as a dynamically regulated supply voltage for circuit blocks. It is further noted that the reference bias current (I_{BIAS}) can be designed such that the resulting current after flowing through the triode MOS devices can be relatively independent of process and/or temperature variations. Although in the end, the reference bias current (I_{BIAS}) will likely depend on some voltage and some resistance, and, as such, the reference bias current (I_{BIAS}) itself will likely have some variation due to the operational conditions for the integrated circuit.

FIG. 4B provides a diagram 400B showing changes in a dynamic supply voltage as a function of a reference current. In this diagram 400B, the x-axis 424 represents the level of the bias current voltage (V_{BIAS}), and the y-axis 422 represents the level of the dynamic supply voltage (V_{SUPPLY}). As depicted, the dynamic supply voltage (V_{SUPPLY}) is configured to follow a linear response 420 with respect to a reference bias current (I_{BIAS}). In particular, the linear response 420 is configured to follow the equation V_{SUPPLY}=V_{O}+βI_{BIAS} where V_{O} represents an initial voltage level 426 and where β represents the slope 428 of the linear response 420. The dynamic supply voltage can be implemented, for example, using the circuit of FIG. 4A, or any other desired circuit that will vary according to process and/or environmental variations. As stated above, this dynamic supply voltage (V_{SUPPLY}) can be utilized to provide a supply voltage to a circuit block. It is noted that the slope (β) 428 for the linear response 420 can be selected to be any desired value. The slope (β) 428 has units of Ohms and otherwise behaves in a similar manner to the slope (α) 318 of FIG. 3B. It is also noted that as with FIG. 3B, a non-linear response can also be utilized, if desired, for the relationship between the dynamic supply voltage (V_{SUPPLY}) and the reference bias current (I_{BIAS}).

As described herein, therefore, circuit blocks within integrated circuits can be biased with dynamic supply voltages so that their operational integrity is maintained through process and environmental changes while their current consumption is reduced. The dynamic supply voltage can be configured to be dependent upon a variable reference voltage or to be dependent upon a variable reference current or both, as desired. To implement a dynamic supply voltage, circuit elements can be used that will vary based upon process and environmental changes. In this way, integrated circuit designs can avoid the use of a constant supply voltage that satisfies all expected process and environmental variations because the use of such a constant supply voltage will tend to cause more current and power to be consumed that is necessary to achieve desired operational speeds under typical process and environmental conditions.

It is noted that the reference bias current (I_{BIAS}) can be programmably selected and chosen so as to set the initial operating point of the dynamic supply voltage used for biasing the circuit blocks. As such, this reference bias current (I_{BIAS}) can be programmable in order to account for different operating conditions of the integrated circuit. In other words, a selection can be made from two or more bias current settings depending upon an expected operational application for the integrated circuit. In this way, an initial value for the supply voltage can be increased or decreased depending on the expected operational application for the circuit blocks being biased by the dynamic supply voltage. For example, a larger reference bias current (I_{BIAS}) may be selected and programmed for a higher frequency VCO circuit whereas a lower reference bias current (I_{BIAS}) may be selected and programmed for a lower frequency VCO circuit. After the reference bias current (I_{BIAS}) is selected and programmed, the initial operating voltage of the dynamic supply voltage is set, and the dynamic supply voltage is then allowed to vary proportionally to temperature and process variations of the MOS transistors as to maintain a desired bias for the circuit blocks biased by this dynamic supply voltage. As such, the circuit can be biased with a different initial supply voltage depending upon the operational conditions for the integrated circuit. It is further noted that the reference bias current (I_{BIAS}) will have some variation based upon the operational conditions for the integrated circuit even though these variations can be reduced with circuit techniques, calibration, and/or programmability.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method of operating a circuit block with a dynamic supply voltage, comprising:
operating an integrated circuit;
generating within the integrated circuit a supply voltage;
allowing one or more circuit elements to cause the supply voltage to vary dynamically due to process or environmental parameters or both to generate a dynamic supply voltage; and
utilizing the dynamic supply voltage for a circuit block within the integrated circuit.

2. The method of claim 1, wherein the environmental parameters comprise temperature.

3. The method of claim 1, wherein the allowing step comprises allowing the supply voltage to vary dynamically based upon a reference voltage that varies due to process or environmental parameters or both.

4. The method of claim 3, further comprising generating the reference voltage utilizing one or more transistors.

5. The method of claim 4, further comprising utilizing diode-connected MOSFET transistors to generated the reference voltage.

6. The method of claim 1, wherein the allowing step comprises allowing the supply voltage to vary dynamically based upon a reference current that varies due to process or environmental parameters or both.

7. The method of claim 6, further comprising generating the reference current utilizing one or more transistors.

8. The method of claim 7, further comprising utilizing a source of a MOSFET transistor to provide the dynamic supply voltage.

9. The method of claim 1, wherein the utilizing step comprises utilizing the dynamic supply voltage for a voltage controlled oscillator.

10. The method of claim 1, wherein the integrated circuit is a CMOS integrated circuit.

11. The method of claim 1, wherein the generating step comprises programmably selecting an initial value for the supply voltage.

12. The method of claim 11, further comprising programmably selecting an value for a bias current with to programmably select the initial value for the supply voltage.

13. The method of claim 12, further comprising selecting from two or more bias current settings depending upon an expected operational application for the integrated circuit.

14. An integrated circuit having a circuit block with a dynamic supply voltage, comprising:
a supply voltage circuit integrated within an integrated circuit and configured to generate a supply voltage for one or more circuit blocks, the supply voltage circuit comprising one or more circuit elements configured to cause the supply voltage to vary dynamically due to process or environmental parameters or both to generate a dynamic supply voltage; and
a circuit block integrated within the integrated circuit and coupled to receive the dynamic supply voltage from the supply voltage circuit as the supply voltage for the circuit block.

15. The integrated circuit of claim 14, wherein the environmental parameters comprise temperature.

16. The integrated circuit of claim 14, wherein the one or more circuit elements are configured to cause the supply voltage to vary dynamically based upon a reference voltage that varies due to process or environmental parameters or both.

17. The integrated circuit of claim 16, further wherein the one or more circuit elements comprise one or more transistors.

18. The integrated circuit of claim 17, wherein the transistors comprise diode-connected MOSFET transistors configured to generate the reference voltage.

19. The integrated circuit of claim 14, wherein the one or more circuit elements are configured to cause the supply voltage to vary dynamically based upon a reference current that varies due to process or environmental parameters or both.

20. The integrated circuit of claim 19, wherein the one or more circuit elements comprise one or more transistors.

21. The integrated circuit of claim 20, wherein the one or more circuit elements comprise a MOSFET transistor configured such that the dynamic supply voltage is provided from the source of the MOSFET transistor.

22. The integrated circuit of claim 14, wherein the circuit block comprises a voltage controlled oscillator.

23. The integrated circuit of claim 14, wherein the integrated circuit is a CMOS integrated circuit.

24. The integrated circuit of claim 14, wherein an initial value for the supply voltage is configured to be programmably selected.

25. The integrated circuit of claim 24, wherein a bias current is configured to be programmably selected in order to programmable select the initial value for the supply voltage.

26. The integrated circuit of claim 25, wherein the bias current can be selected from two or more bias current settings depending upon an expected operational application for the integrated circuit.
